(19) United States
(12) Patent Application Publication
(10) Pub. No.: US 2003/0061587 A1
(43) Pub. Date: Mar. 27, 2003

(54) Method and apparatus for visualizing optical proximity correction process information and output

(75) Inventors: Youping Zhang, Santa Clara, CA (US); Christophe Pierrat, Santa Clara, CA (US)

Correspondence Address: NUMERICAL C/O PARK, VAUGHAN & FLEMING LLP, SUITE 201, 508 SECOND STREET, DAVIS, CA, 95616-4692, US

(73) Assignee: Numerical Technologies, Inc., San Jose, CA

(21) Appl. No.: 09/960,669

(22) Filed: Sep. 21, 2001

(51) Int. Cl. G06F 17/50

(52) U.S. Cl. 716/11; 716/10; 716/2

(57) ABSTRACT

One embodiment of the invention provides a system to facilitate visualization of optical proximity corrections to a circuit layout. This system operates by receiving an input circuit layout and a set of optical proximity correction parameters. The system performs an optical proximity correction on this input circuit layout using the set of optical proximity correction parameters. The output of the optical proximity correction process includes an output circuit layout with optical proximity corrections. This output also includes additional information that allows a user to visualize how the set of optical proximity corrections were determined. Notably, the additional information can be stored in the same representation as the output circuit layout and viewed with the same viewer used for viewing the output circuit layout.

### BACKGROUND

1. Field of the Invention

The invention relates to the process of designing an integrated circuit. More specifically, the invention relates to a method and an apparatus for displaying optical proximity correction process information and output for an integrated circuit design.

2. Related Art

Recent advances in integrated circuit technology have largely been accomplished by decreasing the feature size of circuit elements on a semiconductor chip. As the feature size of these circuit elements continues to decrease, circuit designers are forced to deal with problems that arise as a consequence of the optical lithography process that is typically used to manufacture integrated circuits. This optical lithography process generally begins with the formation of a photoresist layer on the surface of a semiconductor wafer. A mask composed of opaque regions, which are generally formed of chrome, and light-transmissive clear regions, which are generally formed of quartz, is then positioned over this photo resist layer coated wafer. (Note that the term “mask” as used in this specification is meant to include the term “reticle.”) Light is then shone on the mask from a visible light source, an ultraviolet light source, or more generally some other type of electromagnetic radiation together with suitably adapted masks and lithography equipment.

This light is generally reduced and focused through an optical system that contains a number of lenses, filters and mirrors. The light passes through the clear regions of the mask and exposes the underlying photoresist layer. At the same time, the light is blocked by opaque regions of the mask, leaving underlying portions of the photoresist layer unexposed.

The exposed photoresist layer is then developed, through chemical removal of either the exposed or non-exposed regions of the photoresist layer. The end result is a semiconductor wafer with a photoresist layer having a desired pattern. This pattern can then be used for etching underlying regions of the wafer.

One problem that arises during the optical lithography process is “line end shortening” and “pullback”. For example, the upper portion of FIG. 1 illustrates a design of a transistor with a polysilicon line 102, running from left to right, that forms a gate region used to electrically couple an upper diffusion region with a lower diffusion region. The lower portion of FIG. 1 illustrates a printed image that results from the design. Note that polysilicon line 102 has been narrowed using optical phase shifting in order to improve the performance of the transistor by reducing the resistance through the gate region.

Also note that because of optical effects and resist pullback there is a significant amount of line end shortening. This line end shortening is due to optical effects that cause the light to expose more of the resist under a line end than under other portions of the line.

In order to compensate for line end shortening, users, e.g. CAD engineers, photo engineers, or the like, often add additional features, such as “hammer heads,” onto line ends (see top portion of FIG. 2). The upper portion of FIG. 2 illustrates a design of a transistor with a polysilicon line 202, running from left to right, that forms a gate region used to electrically couple an upper diffusion region with a lower diffusion region. Hammer heads 204 are included on the line ends of polysilicon line 202 to compensate for the line end shortening described above in conjunction with FIG. 1. As is illustrated in the bottom portion FIG. 2, these additional features can effectively compensate for line end shortening in some situations.

These additional features are typically added to a layout automatically during a process known as optical proximity correction (OPC). However, the optical proximity correction process can be complicated by the fact that the user has little insight into how OPC corrections were made. For example, FIG. 3 illustrates line end geometry 302 (solid line) prior to OPC and the corrected line end geometry 304 after OPC (dashed line). There may be areas of corrected line end geometry 304 which do not fully compensate for the optical effects. After OPC, the user may want to manually change the input circuit geometry to better facilitate OPC.

Determining how to change the input circuit geometry is difficult, however, because the user does not know how the OPC process arrived at the automatic corrections. For example, with model based OPC processes, the original geometry is segmented at dissection points where the original lines of the layout are divided and permitted to move. Additionally, one or more evaluation points are positioned relative to each line segment. In some embodiments, the evaluation points may not be on the original line segment. In other embodiments, multiple evaluation points may be used for a single line segment. The evaluation points are the locations relative to the line segments where the simulated image of the layout is computed and then the line segments are adjusted about the dissection points to bring the simulated image as close as possible to the target image, e.g. the original layout. The location of the evaluation and dissection points are not readily apparent, for example there may be a dissection point 306 located as shown on the side of the line end geometry 302. The user can make assumptions about whether or not the dissection point 306 exists at all and where it is located, but solely from the output the locations are not easy to discern. Additionally, the user does not know where the evaluation points lie on the original geometry, or what criteria OPC used in terminating the process. For example, is the hammerhead correction of the corrected line end geometry 304 sufficient to correct for line end shortening or did the OPC process have to stop correction because the maximum allowable correction was reached, etc.

What is needed is a method and an apparatus to allow the user to visually determine where dissection points and evaluation points lie, what OPC corrections were made, and the terminating criteria for segments that were not fully corrected.

### SUMMARY

One embodiment of the invention provides a system to facilitate visualization of optical proximity corrections to a circuit layout. This system operates by receiving an input circuit layout and a set of optical proximity correction parameters. The system performs an optical proximity correction on this input circuit layout using the set of optical proximity correction parameters. The output of the optical proximity correction process includes an output circuit layout with optical proximity corrections. This output also includes additional information that allows a user to visualize how the set of optical proximity corrections were determined.

In one embodiment of the invention, the input circuit layout is in GDSII format.

In one embodiment of the invention, the output circuit layout is in GDSII format.

In one embodiment of the invention, the additional information comprises at least one additional layer of GDSII output.

In one embodiment of the invention, the additional information is formatted to be viewed using the same viewer that is used to view the output circuit layout.

In one embodiment of the invention, the system generates multiple additional layers. These additional layers include layers for multiple iterations of the optical proximity correction so that the user can visualize how changes to the circuit layout were made by sequentially viewing the additional layers.

In one embodiment of the invention, the additional output includes an optical proximity correction action for an evaluation point.

In one embodiment of the invention, performing the optical proximity correction includes performing a model-based optical proximity correction.

In one embodiment of the invention, performing the optical proximity correction includes performing a rule-based optical proximity correction.

In one embodiment of the invention, the additional output includes dissection points that are used to dissect polygon edges in the circuit layout to form optical proximity correction segments.

In one embodiment of the invention, the additional output includes evaluation points that are used as points for calculating optical proximity corrections for optical proximity correction segments.

### BRIEF DESCRIPTION OF THE FIGURES

FIG. 1 illustrates the line end shortening problem.

FIG. 2 illustrates the use of a hammerhead to compensate for the line end shortening problem.

FIG. 3 illustrates line end geometry prior to and after optical proximity correction.

FIG. 4 illustrates line end geometry including additional layers after optical proximity correction in accordance with an embodiment of the invention.

FIG. 5 is a flowchart illustrating the process of optical proximity correction including producing additional output in accordance with an embodiment of the invention.

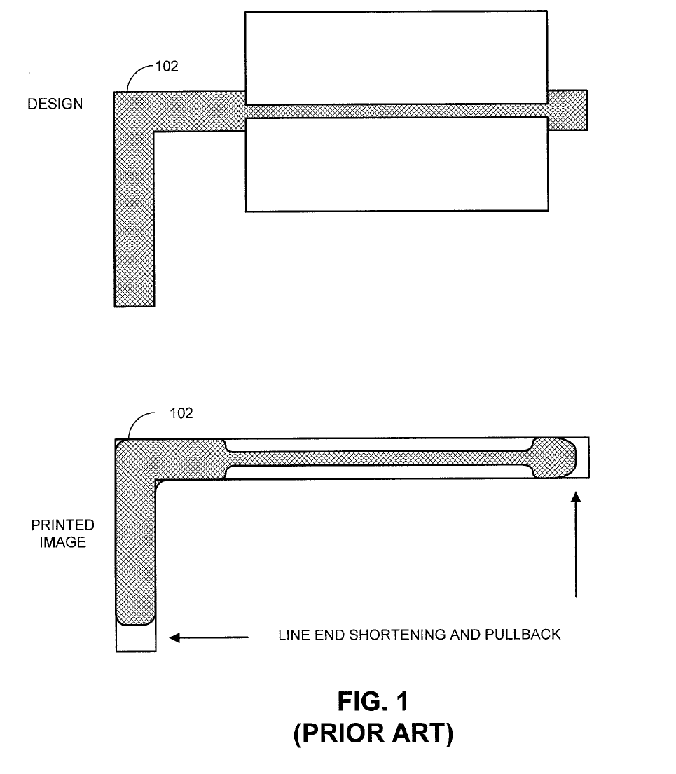

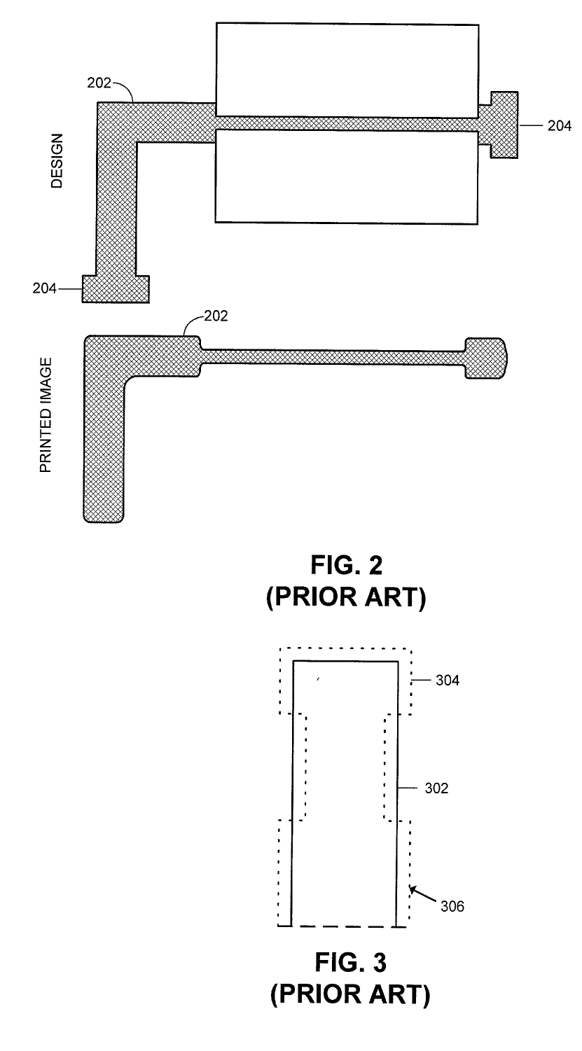

### DETAILED DESCRIPTION

Optical Proximity Correction Output

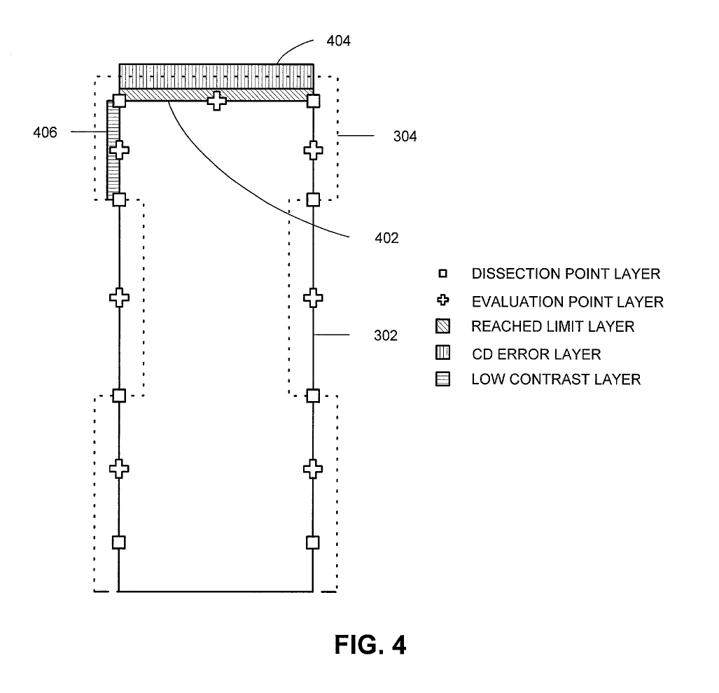

FIG. 4 illustrates line end geometry including additional layers after optical proximity correction (OPC) in accordance with an embodiment of the invention. Within FIG. 4, line end geometry 302 prior to OPC and corrected line end geometry 304 after OPC are illustrated along with additional information about the OPC process. Note that this additional information may be located on separate layers of the output circuit layout. Also note that the additional layers may be heavily subdivided, e.g. different layers indicating differing amounts of out-of-tolerance for a feature critical dimension (CD). In some embodiments, the additional layers may be combined into a single additional layer with OPC process visualization information.

Within FIG. 4, dissection points are indicated by squares on a dissection point layer. A dissection point is a point on a line segment where an optical proximity correction segment begins and/or ends. Evaluation points are indicated by pluses on an evaluation point layer. An evaluation point is a point on a line segment where the OPC process calculates corrections for an optical proximity correction segment. During the update phase of OPC, an optical proximity correction segment is moved, or biased, by an amount based upon the deviation of the printed image from the target image at the evaluation points representing a segment.

The output may include other layers such as reached limit layer 402, critical dimension (CD) error layer 404, and low contrast layer 406. A reached limit layer 302 indicates line segments that received the maximum allowed correction. For example, the line end of the line end geometry 302 received the maximum correction as shown by the shading of the top line in the reached limit layer. The CD error layer 404 identifies areas where the critical dimension (CD) of the input layout could not be met, and the size of the geometries in the CD error layer 404 can, in some embodiments, indicate the magnitude of the error. For example, larger rectangular regions could indicate larger CD errors, etc.

More specifically, the rectangle can be defined on the layer such that in one dimension, e.g. length, it covers the entire segment it relates to and that in the other dimension, e.g. width, is the closest value that can be represented in the output format to the actual CD measurement (e.g. a CD of 5.7 nm might be represented by a rectangle with width 6 nm.)

Similarly, the low contrast layer 406 identifies image regions where the light intensity gradient is poor, e.g. low slope. Low contrast regions may not print well in the final circuit and so identifying such regions can be valuable to the user. Also note that additional error layers may be generated based on the amount of error. A significant advantage of providing this information within additional layers of the output is that these layers, including the dissection point layer and the evaluation point layer, may be viewed using the same viewer used to view the geometry layers. Thus, a separate viewer is not needed.

Other layers that can be included in the output according to some embodiments of the invention, which can help the user in determining why a segment was not corrected to meet given criteria or why it was corrected in a specific fashion, include:

unhandled shape: shapes that cannot be handled by the OPC process are identified, e.g. 30 degree edges, circles, etc. This facilitates comprehension of which shapes are not being processed.

unanticipated behavior: poorly built models may exhibit behaviors that do not comply with expected optical and/or physical properties when applied to certain edges. The OPC process can identify when such a result occurs and this may suggest that the model should be reconstructed or more closely analyzed.

reached limit: when an edge has reached the maximum allowed correction but the OPC process indicates that further correction outside that limit would be desirable. This may suggest that the maximum allowed correction is insufficient to provide adequate OPC for a design.

low contrast: when the intensity slope (in the printed image) of an evaluation point for an edge falls below a predetermined amount, it is marked low contrast. This helps in the identification of edges, and features, that may print poorly.

high sensitivity: reflects a ratio of CD changes from biasing vs. the bias itself. When the ratio rises above a predetermined amount, the edge is marked sensitive, e.g. a small amount of movement causes a large amount of CD change.

reached model resolution: if an edge still requires refinement, but the model cannot further adjust the edge at the resolution necessary.

unconverged: if the process stops due to reaching the maximum iterations permitted for OPC, edge that still require correction can be designated as unconverged. This will assist the user in determining whether additional iterations should be permitted.

one step correction limited: Like reached limit, but for a given iteration.

skipped: Edge was skipped for current iteration.

within specification: for the current iteration, the edge CD is within the tolerance for the iteration or for the last iteration, is within tolerance. (C.f. unconverged.)

dropped: an edge has been discarded from future correction, e.g. due to unhandled angle, low contrast, etc. (C.f. unhandled shape.)

Process

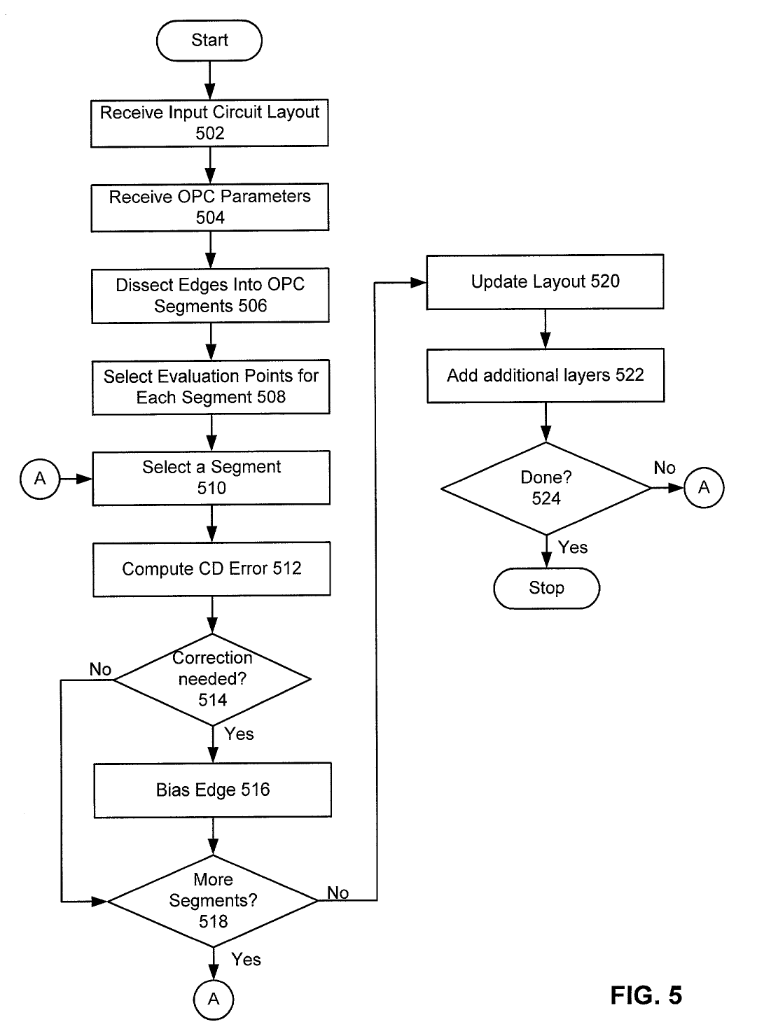

FIG. 5 is a flowchart illustrating the process of optical proximity correction including generating additional output layers in accordance with an embodiment of the invention. The process starts when the system, e.g. a computer, receives an input circuit layout requiring optical proximity correction (OPC) (step 502). This input circuit layout can be received in a standard format, such as GDSII format, mask electronic beam exposure system (MEBES) format, and/or some other format. The input circuit layout can be received by the system over a network, e.g. a local area network, the Internet, a network attached storage network, etc., and/or from storage local to the system, e.g. a hard drive, CD-ROM, DVD, etc.

Next, the system receives OPC parameters for evaluating the input circuit layout (step 504). The OPC parameters can be received in similar fashion to the layout, e.g. over a network, from storage local to the system, and/or from user input. For example, the user might use a keyboard and/or mouse to adjust OPC parameters of the system through a graphical user interface (GUI). In other embodiments, the OPC parameters are specified in a data file, e.g. text, XML, proprietary format, etc.

The system then dissects the polygon edges into OPC segments at dissection points (step 506). This is done in accordance with the OPC parameters. For example, the parameters might specify that segments are to be dissected and evaluated every 120 nm, but that segments on inside corners are to be dissected every 60 nm.

Next, the system places evaluation points for each OPC segment (step 508).

The system then selects a segment for evaluation (step 510).

The process then proceeds in a double loop, the inner loop evaluates each segment once and decides whether or not to perform correction (steps 510-518) the outer loop monitors the overall process and limits computational time, etc. (steps 510-524). The steps will now be described in greater detail.

At step 510, a segment is selected. As noted, during each iteration of the inner loop, each segment will be evaluated once, and optionally corrected, once.

Next, the system calculates a critical dimension (CD) error at the evaluation point on the selected segment (step 512). This can be done by evaluating the optical model of the lithography process at the evaluation point.

The system then determines whether to correct the segment on this iteration through the inner loop (step 514).

If the system decides to correct the segment on this iteration at 514, the system calculates the edge bias to apply on this iteration (step 516). If no correction will be performed this iteration, the process continues at step 518. The amount of bias that can be applied to an edge segment in a single iteration may be limited according to the OPC parameters received at step 504. Additionally, a single edge may be outwardly biased on one iteration, e.g. +5 nm and then further biased on a subsequent iteration. Thus, the model based OPC process is one of continued refinement.

At step 518, if there are more segments to process in this iteration of the inner loop, the process continues at step 510. Otherwise, the process continues at step 520.

At step 520, the system can update the layout with the biases that have been calculated for each segment. This intermediate output may be saved as one of the additional layers, e.g. layer N is iteration 1, layer N+1 is iteration 2, etc. This may facilitate viewing of the process whereby the input circuit layout is transformed into the output circuit layout. Additionally, at step 522 information for additional layers of the type discussed above in conjunction with FIG. 4 can be output. In some embodiments of the invention, the information for the additional layers is generated through steps 502-518 and only periodically written to storage. For example, as the edges are dissected at step 506, the dissection point layer can be constructed with appropriate geometries to indicate dissection points. In some embodiments, step 520 and step 522 are performed only after step 524 indicates that the entire OPC process is concluded.

Finally, the system determines if the stop criteria have been met (step 524). If not, the process returns to 510 to begin another iteration, otherwise, the process is ended. The stop criteria can include reaching a preset maximum number of iterations and/or all segments meeting the maximum correction or fully corrected, etc.

The data structures and code described in this detailed description can be stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Additional Embodiments

In one embodiment, all additional layers are stored in the same format used for the output circuit layout, e.g. GDSII, MEBES, etc. In another embodiment, images of the intermediate layouts (e.g. those generated at step 520 after an iteration of the inner loop) are stored in an image format such as JPEG, GIF, or PNG. In one variation of this embodiment, the intermediate layouts are composed into a viewable movie, e.g. MPEG format. In one embodiment, the OPC parameters 504 may specify specific areas of the input circuit layout where such images should be taken, e.g. only a memory core section of the floorplan, etc. Such a specification facilitates close review of the OPC process for a layout portion while maintaining layout data at a manageable size.

Similarly, in some embodiments the OPC parameters 504 may include information about what portions of the input circuit layout to generate additional visualization information for. For example, in one embodiment, OPC is first performed without generating additional layers and a user reviews the result and identifies layout areas where she/he wants to better understand the OPC correction. The designer can then select the desired additional layers (see discussion of FIG. 4) and the areas of the input circuit layout where she/he wants to see the additional process visualization information.

In one embodiment, the output of additional information about the OPC process can be considered a visualization of (model) data within the running program performing the OPC process. In another embodiment, the additional layers may be adapted to include visual representations of internal state, or debugging information, about the program performing the OPC process. Such internal state can be used to assist a programmer in developing an OPC engine.

Although the foregoing description has primarily been focused on a model based OPC process, the above approach can be suitably adapted to rule based and hybrid (mixture of rule and model) OPC processes.

The foregoing descriptions of embodiments of the invention have been presented for purposes of illustration and description only. They are not intended to be exhaustive or to limit the invention to the forms disclosed. Accordingly, many modifications and variations will be apparent. Additionally, the above disclosure is not intended to limit the invention. The scope of the invention is defined by the appended claims.

What is claimed is:

1. A method to facilitate visualization of optical proximity corrections to a circuit layout, comprising:
receiving an input circuit layout;
receiving a set of optical proximity correction parameters;
performing an optical proximity correction on the input circuit layout using the set of optical proximity correction parameters;
generating an output circuit layout, wherein the output circuit layout includes a set of optical proximity corrections; and
including in the output circuit layout an additional information to support visualization of how the set of optical proximity corrections were determined.

2. The method of claim 1, wherein the additional information is formatted to be viewed using a same viewer that is used to view the output circuit layout.

3. The method of claim 2, further comprising generating a plurality of additional layers, wherein the plurality of additional layers includes layers for multiple iterations of the optical proximity correction, whereby the plurality of additional layers can be viewed sequentially to allow a user to visualize how changes to the circuit layout were made.

4. The method of claim 2, wherein the additional information includes the optical proximity correction for a dissection segment in the input circuit layout.

5. The method of claim 1, wherein performing the optical proximity correction includes performing a model based optical proximity correction.

6. The method of claim 1, wherein performing the optical proximity correction includes performing a rule based optical proximity correction.

7. The method of claim 1, wherein the additional information includes dissection points that are used to dissect edges in the circuit layout to form optical proximity correction segments.

8. The method of claim 7, wherein the additional information includes evaluation points that are used as points for calculating optical proximity corrections for optical proximity correction segments.

9. A computer-readable storage medium storing instructions that when executed by a computer cause the computer to perform a method to facilitate visualization of optical proximity corrections to a circuit layout, the method comprising:
receiving an input circuit layout;
receiving a set of optical proximity correction parameters;
performing an optical proximity correction on the input circuit layout using the set of optical proximity correction parameters;
generating an output circuit layout, wherein the output circuit layout includes a set of optical proximity corrections; and
including in the output circuit layout an additional information to support visualization of how the set of optical proximity corrections were determined.

10. The computer-readable storage medium of claim 9, wherein the additional information is formatted to be viewed using a same viewer that is used to view the output circuit layout.

11. The computer-readable storage medium of claim 10, the method further comprising generating a plurality of additional layers, wherein the plurality of additional layers includes layers for multiple iterations of the optical proximity correction, whereby the plurality of additional layers can be viewed sequentially to allow a user to visualize how changes to the circuit layout were made.

12. The computer-readable storage medium of claim 10, wherein the additional information includes the optical proximity correction for a dissection segment in the input circuit layout.

13. The computer-readable storage medium of claim 9, wherein performing the optical proximity correction includes performing a model based optical proximity correction.

14. The computer-readable storage medium of claim 9, wherein performing the optical proximity correction includes performing a rule based optical proximity correction.

15. The computer-readable storage medium of claim 9, wherein the additional information includes dissection points that are used to dissect edges in the circuit layout to form optical proximity correction segments.

16. The computer-readable storage medium of claim 15, wherein the additional information includes evaluation points that are used as points for calculating optical proximity corrections for optical proximity correction segments.

17. An apparatus to facilitate visualization of optical proximity corrections to a circuit layout, comprising:
a receiving mechanism that is configured to receive an input circuit layout;
wherein the receiving mechanism is further configured to receive a set of optical proximity correction parameters;
an optical proximity correction mechanism that is configured to perform an optical proximity correction on the input circuit layout using the set of optical proximity correction parameters; and
an output mechanism that is configured to generate an output circuit layout, wherein the output circuit layout includes a set of optical proximity corrections;
wherein the output mechanism is further configured to include in the output circuit layout an additional information to support visualization of how the set of optical proximity corrections were determined.

18. The apparatus of claim 17, wherein the additional information is formatted to be viewed using a same viewer that is used to view the output circuit layout.

19. The apparatus of claim 18, wherein the output mechanism is further configured to output a plurality of additional layers, wherein the plurality of additional layers includes layers for multiple iterations of the optical proximity correction, whereby the plurality of additional layers can be viewed sequentially to allow a user to visualize how changes to the circuit layout were made.

20. The apparatus of claim 18, wherein the additional information includes the optical proximity correction for a dissection segment in the input circuit layout.

21. The apparatus of claim 17, wherein the optical proximity correction mechanism is further configured to perform a model based optical proximity correction.

22. The apparatus of claim 17, wherein the optical proximity correction mechanism is further configured to perform a rule based optical proximity correction.

23. The apparatus of claim 17, wherein the output mechanism is further configured to generate dissection points that are used to dissect edges in the circuit layout to form optical proximity correction segments.

24. The apparatus of claim 23, wherein the output mechanism is further configured to output evaluation points that are used as points for calculating optical proximity corrections for optical proximity correction segments.

25. A system to facilitate visualization of optical proximity corrections to a circuit layout, comprising:
a means for receiving an input circuit layout;
a means for receiving a set of optical proximity correction parameters;
a means for performing an optical proximity correction on the input circuit layout using the set of optical proximity correction parameters;
a means for generating an output circuit layout, wherein the output circuit layout includes a set of optical proximity corrections; and
a means for generating an additional output containing information that allows a user to visualize how the set of optical proximity corrections were determined, wherein the additional output is formatted for a same viewer used for the output circuit layout, and wherein the additional output includes an optical proximity correction action for an evaluation point.

26. A method of manufacturing an integrated circuit product, comprising:
receiving an input circuit layout;
receiving a set of optical proximity correction parameters;
performing an optical proximity correction on the input circuit layout using the set of optical proximity correction parameters;
generating an output circuit layout, wherein the output circuit layout includes a set of optical proximity corrections;
including in the output circuit layout an additional information to support visualization of how the set of optical proximity corrections were determined;
creating a mask using the output circuit layout; and
manufacturing the integrated circuit product from the mask.
